(19) United States
(12) Patent Application Publication
(10) Pub. No.: US 2026/0297719 A1
(43) Pub. Date: Oct. 1, 2026

(54) DEVICE FOR IMPROVING PREOXIDATION IN AN ANNEALING FURNACE

(71) Applicant: John Cockerill S.A., Seraing (BE)

(72) Inventor: Michel DUBOIS, Boncelles (BE)

(21) Appl. No.: 18/880,577

(22) PCT Filed: Jun. 23, 2023
(86) PCT No.: PCT/EP2023/067151

§ 371 Date: Jan. 2, 2025

(30) Foreign Application Priority Data
Jul. 5, 2022 (EP) 22183162.1

(51) Int. Cl. C23C 2/02

(52) U.S. Cl. CPC C23C 2/0222

(57) ABSTRACT

A method for improving temperature longitudinal homogeneity of a steel strip being a low carbon alloyed steel strip dedicated to liquid metal coating includes: continuously running the steel strip at a line speed in a temperature homogenization section provided with electric resistances, the temperature homogenization section being located before a post-treatment section and after a furnace section, the furnace section providing a radiative or electric heating of the steel strip to a predetermined average temperature, the temperature homogenization section including at least one contact roll comprising refractory stainless steel, the at least one contact roll having a strip wrapping angle higher than 90°. A total contact time and a total contact length, respectively, of the strip with the at least one contact roll are greater or equal to

$$ContactTime 1 = ( A * exp ( B * RSTGDP ) ) * strip thickness$$

$$and$$

$$ContactLength 1 = ContactTime 1 * line speed .$$

### CROSS-REFERENCE TO PRIOR APPLICATIONS

This application is a U.S. National Phase application under 35 U.S.C. § 371 of International Application No. PCT/EP2023/067151, filed on Jun. 23, 2023, and claims benefit to European Patent Application No. EP 22183162.1, filed on Jul. 5, 2022. The International Application was published in English on Jan. 11, 2024 as WO/2024/008480 under PCT Article 21(2).

### FIELD

The present invention relates to the heating process used in annealing lines of cold rolled steel strips of high strength, especially those intended for the automotive industry. The invention also concerns the industrial installation for carrying out the heating process.

### BACKGROUND

The heating process that is commonly used in annealing lines for low carbon strips uses heat transfer by radiation. The latter may be obtained by direct flame radiation in the enclosure where the strip is travelling as it is the case in a so-called “direct fired furnace” (DFF). An alternative technology uses the radiation of a tube internally heated either electrically or by using a flame (radiant tube furnace or RTF), that last method being the most common due to the high heating power (in watt per m²) that can be delivered by the heating surface. If both methods are well-known and commonly used industrially, they completely differ by the fact that in case of direct flame heating the combustion gas are in contact with the processed strip whereas, in the alternative method, they are contained in the heating tube and so have no direct contact with the strip surface.

Other differences exist and they can be quickly summarized as follows:
the surface radiating toward the strip is at much higher temperature in case of a direct fired furnace, typically between 120° and 1450° C. in case of direct fired furnace while it is limited to maximum 1150° C. or more commonly 950° C. when the radiant tubes are made of refractory steels due to creeping and heat expansion phenomena;
the heat transfer is obtained exclusively by radiation in case of radiant tubes while about 10 to maximum 20% of the heat transfer is also obtained by convection in case of the direct fired technology.

It is well-known that the total heat transfer power results from the sum of convective and radiative heat transfers and that the radiative one is proportional to the difference of temperature in kelvin at the 4th power between the hot and the cold body. It can be shown that if the temperature difference between the hot and the cold body is higher that about 500° C. the temperature of the cold body has no effect and the radiative heat transfer is then only proportional to the 4th power of hot body temperature multiplied by the shape factor and the emissivity of the hot and cold surfaces as well as by the Boltzmann constant. Considering the classical values of temperature and emissivity used industrially on a cold rolled steel annealing cycle, the heating rate from room temperature to 650° C. is in the range of 35 to 45° C./sec for a 1 mm strip thickness in a direct fired furnace and only of 10 to 15° C./sec in a radiant tube furnace.

In case of a the steel surface with non-uniform emissivity, the heat transfer delivered per surface unit is not identical in each point: a high surface emissivity, low surface emissivity respectively, will induce a higher heat input, lower heat input respectively, into the running strip. In case the strip emissivity varies as it is usually the case along and across the strip, non-uniform longitudinal and transversal temperatures may be obtained. The emissivity variations are due to variable cleanliness or oxidation of the surface. It is for example common to observe variations between head, tail and middle of a coil but also between edge and center thereof. Many causes in the upstream process of flat low carbon steel can explain that fact even if all of them are not yet well identified. It is also important to note that, even if the strip has a thermal conductivity, this one is significantly lower than the one of copper or aluminium for example, and is too low to allow some uniformization of the temperature due to the generally large distance between hot and cold parts.

To give an example, a 1 mm thick strip with an emissivity variation of only +10%, that is to say 0.35, on a strip of 100 mm width, while all the rest of the strip remains at 0.315, induces a temperature difference of about 35° C. when the average temperature is 650° C.

It is also known that many measures are taken nowadays in the frame of industrial CO₂ reduction. One of them relates to an increase of the strength of the steel used, especially in the automotive industry. However, this increase of hardness requires to add some alloying elements in addition to carbon, the most commonly used being Mn, Si, Cr, P and sometimes Nb, V, and Ti, the total amount of alloying elements being most usually below 3%.

It is also well-known that, during the heat treatment prior to coating by dipping in a liquid metal like Zn or Al or a mixture thereof, intended to improve corrosion resistance, the elements added to increase strength diffuse to and oxidize the strip surface. When the surface of the steel is covered by too many oxides, wetting said surface with the coating liquid metal is strongly disturbed and the coating makes surface defects and/or has poor adhesion to the steel. As a solution to that problem it is known to propose performing a surface preoxidation of both Fe and the alloying elements between 65° and 750° C., and preferably between 650 to 700° C. It is however also known that, if the oxidation kinetics is quite sensitive to the strip temperature, this is mostly the case in direct fired furnace due to the contact between the exhaust gas and the strip. Therefore, when entering specifically a preoxidation process step as described in the previous patent of the applicant, EP 3 286 343 B1 (to which the present application is complementary), a non-uniform strip temperature induces variable oxide thickness and morphology. This may further disturb subsequent reduction of the Fe oxide and consequently suitable surface preparation of the strip before entering the coating pot.

The inventors confirm that the quality of the final product is improved when the oxidation is reasonably uniform/homogeneous. Considering the explanations above, it practically means that the strip temperature uniformity must be good enough, that means a strip temperature within +/−10° C. but more preferably within +/−5° C., at the time the strip enters in the preoxidation box.

When the strip emissivity varies along the strip, a way to compensate for having constant strip temperature at the exit of the temperature homogenization section could be to change the line speed. However this is not always feasible practically because the variations of temperature should be anticipated, for example by a measure of the strip emissivity at the entry of the furnace, what is not the common practice.

Changing the firing rate of the furnace is another possibility but the practice has shown that the compensation of a too cold or too hot local area induces problems on the sections that otherwise have normal emissivity. This is well-known by the operators. Without giving here a too detailed explanation, this is because the reduction in firing rate has an impact on the temperature of the furnace and the latter has a quite slow response. The problem is also (and this is well-known by the engineers) that measuring the true strip temperature with a non-contact system is difficult when the emissivity varies unexpectedly.

Document US 2017/137906 A1 relates to cold rolled and hot dip high-strength multiphase steels, for motor vehicles use, which have high formability properties and exhibit high resistance levels, and are intended to be used as structural members and reinforcing materials primarily for motor vehicles. The cold rolled sheet is heated in a DFF within an atmosphere having an excess volume oxygen percentage between 0.2% and 4%. Excess oxygen volume refers to the oxygen that is present in excess of the necessary oxygen quantity to combine with the fuel used to heat the furnace, i.e.: Excess Volume Oxygen percentage=(Total oxygen volume-oxygen volume needed for combustion)/(total oxygen volume). Thus, when excess oxygen is present in the combustion atmosphere within the proportion of this disclosure, it is available to react with the steel strip. In the range between 50° and 750° C., oxidation takes place, i.e. a layer of iron oxide is formed on the surface of the steel sheet while an internal oxidation occurs under this iron oxide: internal oxides within a depth of 100 μm, which can contain one or more of Si, Mn, Al, Ti, are thus created. If the oxidation depth is above 100 μm, the steel surface will be heavily oxidized, which will be difficult to be reduced, and coating quality will be deteriorated.

During heating, annealing and cooling steps, steel is oxidized and then reduced, i.e. the iron oxide layer at the surface of the steel sheet, mentioned above, is fully reduced, while an internal oxidized zone, with a depth between 200 nm and 100 μm, comprising one or more of Si, Mn, Al, Ti containing oxides, is present. This oxidation followed by a reduction step is necessary so that the steel surface is suitable for hot dip coating.

In document EP 3 686 534 B1 it is intended to provide a process for the heat treatment of a strip of high-strength steel making it possible to obtain on its surface an oxide formation with a more homogeneous and more controlled thickness than in art.

It is known that the use of a direct flame heating zone allows a rapid rise in temperature of the strip to the detriment of the temperature uniformity of the metal product. As in a large number of furnaces, the oxidation chamber is positioned directly after the direct flame heating zone, the oxidation is carried out on a strip whose temperature uniformity is not well controlled.

The kinetics of formation of an oxide layer on the surface of a strip of high strength steel depends mainly on the surface temperature of the strip, the steel composition and of course time, as well as the composition of the oxidizing atmosphere in the chamber of oxidation. The oxidation time is defined by the line speed and the section length. So good control of the temperature of the strip during its oxidation in the oxidation chamber makes it possible to obtain a surface oxide layer having a more homogeneous thickness over the entire surface of the strip.

However, in relation with the intended temperature inhomogeneity target (e.g. between 1 and 5%) and the strip speed, this patent does not teach the length of the homogenization chamber, nor the time to be spent by the strip in that chamber, which renders the teaching of poor practical use for the skilled person.

### SUMMARY

In an embodiment, the present invention provides a method for improving temperature longitudinal homogeneity of a steel strip comprising a low carbon alloyed steel strip dedicated to liquid metal coating, the method comprising: continuously running the steel strip at a line speed in a temperature homogenization section provided with electric resistances, the temperature homogenization section being located before a post-treatment section and after a furnace section, the furnace section being configured to provide a radiative or electric heating of the steel strip to a predetermined average temperature, the temperature homogenization section including at least one contact roll comprising refractory stainless steel, the at least one contact roll having a strip wrapping angle higher than 90°, wherein a total contact time and a total contact length, respectively, of the strip with the at least one contact roll are selected to be greater or equal to

$$ContactTime 1 = ( A * exp ( B * RSTGDP ) ) * strip thickness$$

$$and$$

$$ContactLength 1 = ContactTime 1 * line speed$$

$$where :$$

$$RSTGDP = ( 1 - \frac{Initial roll temperature - Actual strip temperature}{Initial roll temperature - Initial strip temperature} ) \times 100$$

ContactLength1 is in m, ContactTime1 in sec, line speed in m/sec, and 0.34<A<0.92 and 0.035<B<0.045,
wherein ContactTime1 is limited to a value necessary to attain a predetermined upper value of RSTGDP, the initial roll temperature, and
wherein the initial and actual strip temperatures in the temperature homogenization section are measured by temperature measurement devices.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is representing the different thermal treatments in an annealing line of cold rolled steel strips of high strength needed to prepare the strip for metal liquid coating, including a temperature homogenization section according to prior art, in which rolls are provided, made of refractory stainless steel with a thickness between 20 and 30 or 40 mm

FIG. 2 shows an example for the evolution of the transversal strip temperature gradient in function of time.

FIG. 3A to 3D show different configurations for a temperature homogenization section, mainly differing by the number and the location of the resistances (FIGS. 3A and 3B, transversal homogenization; FIGS. 3C and 3D, longitudinal homogenization) and contact rolls and/or the strip wrapping angle of the rolls (FIGS. 3C and 3D).

FIG. 4 shows the time evolution of the roll/strip temperature gradient for a roll thickness of 25 mm

FIG. 5 shows the respective variations of strip temperature and of roll surface temperature with the time spent in the dedicated homogenization section, considering a roll initially at 650° C. and a strip entering in the section at 600° C. (1 mm strip, rolls made of refractory steel and with a shell thickness of 25 mm).

FIG. 6 shows equations of a model on which the results presented in FIGS. 2, 4 and 5 have been based.

### DETAILED DESCRIPTION

In an embodiment, the present invention provides a solution to overcome the drawbacks of prior art.

To this end, the inventors propose a process for the heat treatment of a moving high-strength steel strip, comprising a step of strip temperature homogenization in a homogenization chamber comprising at least one radiant heating tube under a no-oxygen atmosphere, so as to homogenize the temperature of the strip after it has passed through the direct flame heating zone of the previous step, and before a step of oxidizing the strip in an oxidation chamber with an oxidizing atmosphere having an oxygen concentration by volume greater than 1%, and further a step of strip reduction in a reduction zone.

In particular, in an embodiment the invention provides improved longitudinal and transversal temperature homogeneity of a strip after the step of heating the same in a DFF or a RTF furnace and before the step of preoxidation, inhomogeneity being mostly attributed to local variation of strip emissivity.

Moreover, in an embodiment the invention provides guidelines in terms of designing the length of a homogenization section needed and residence time of the strip therein in order to attain a predetermined temperature homogeneity target at the exit of the section.

A first aspect of the present invention relates to a method for improving temperature longitudinal homogeneity of a steel strip, in particular a low carbon alloyed steel strip dedicated to liquid metal coating, continuously running at a line speed in a temperature homogenization section provided with electric resistances, said temperature homogenization section being located before a critical process like a post-treatment section and after a furnace section, said furnace section being able to provide a radiative heating of the strip to a predetermined average temperature, wherein said temperature homogenization section is further provided with at least one contact roll made of refractory stainless steel having a strip wrapping angle higher than 90°, preferably 270° or more, and wherein the total contact time, the total contact length respectively, of the strip with the at least one contact roll are selected greater or equal to

$$ContactTime 1 = ( A * exp ( B * RSTGDP ) ) * strip thickness$$

$$and$$

$$ContactLength 1 = ContactTime 1 * line speed$$

$$where :$$

$$RSTGDP = ( 1 - \frac{Initial roll temperature - Actual strip temperature}{Initial roll temperature - Initial strip temperature} ) \times 100$$

ContactLength1 is in m, ContactTime1 in sec, line speed in m/sec; and
0.34<A<0.92 and 0.035<B<0.045 (note that A and B coefficients are for refractory stainless steel rolls only),
said ContactTime1 being limited to a value necessary to attain a predetermined upper value of RSTGDP, the initial roll temperature, the initial and actual strip temperatures in the temperature homogenization section being measured by temperature measurement devices.

According to preferred embodiments, the method is further limited by at least one of the following characteristics or a suitable combination of these characteristics:
the total contact time ContactTime1 is adjusted or limited to obtain a reduction by 25%, respectively by 50%, of the longitudinal temperature variation of the strip;
the temperature of the temperature homogenization section provided with rolls is controlled by setting the temperature of the electric resistances at the average value to obtain the temperature value required for the strip entering the preoxidation section, said electric resistances having the function of compensating thermal loss;
the temperature homogenization section provided with rolls is maintained under an atmosphere with less than 0.5% O₂;
the temperature homogenization section provided with rolls is maintained under an atmosphere having a dew point between −60 and 0° C., preferably between −30 and −10° C.;
the method is also intended for improving temperature transversal homogeneity of the strip, wherein, in said temperature homogenization section or in another section, electric resistances distributed on the walls of the said section are heating the section on a length that is given in the following equation that depends on the percentage of the transversal strip temperature gradient decrease percentage or STGDP:

$$ContactTime 2 = A * exp ( B * STGDP )$$

$$and$$

$$ContactLength 2 = ContactTime 2 * line speed$$

$$where :$$

$$STGDP = ( \frac{Initial gradient - final gradient}{Initial gradient} ) \times 100 ;$$

ContactLength2 is in m, ContactTime2 in sec, line speed in m/sec;
2.8<A<3.3 and 0.03<B<0.04 (note that A and B coefficients are for refractory stainless steel rolls only);
the method is operated with low carbon alloyed steel strip dedicated to be coated with in a mixture of liquid Zn and Al, possibly with Si, Fe, and with inevitable impurities;
the method is operated with a preoxidation section or a soaking section as post-treatment section;
the method is operated with a direct flame furnace, a radiant tube furnace or an electric induction furnace as furnace section;
the method is operated with a furnace section being maintained under an atmosphere containing less than 1% O₂ and one or more components selected from the group consisting of H₂, CO, H₂O, CO₂, N₂ and a mixture thereof, in respective proportions depending on processing parameter settings;
the strip tension is advantageously comprised between 0.3 and 1.5 kg/mm², and preferably between 0.5 and 1 kg/mm²;
the temperature difference between the strip entering the temperature homogenization section and the at least one contact roll is lower than 100° C., preferably lower than 50° C.

Another aspect of the invention relates to an industrial installation for carrying out the method for improving longitudinal and transversal temperature homogeneity of a steel strip, preferably a low carbon alloyed steel strip dedicated to liquid metal coating, continuously running at a line speed in a temperature homogenization section comprising a tunnel or a chamber provided with electric resistances, as described above, said strip having given thickness and tension, wherein said installation successively comprises:
a direct flame, radiant tube or electric induction furnace section;
said temperature homogenization section which is further provided with at least one contact roll with a given diameter, providing a strip wrapping angle, depending on the ratio roll diameter/strip thickness and on said strip tension, higher than 90°, preferably higher than 270° or more, and able to provide a total contact time, a total contact length respectively, of the strip with the at least contact roll fulfilling the conditions specified above, said contact time depending on the roll-strip temperature gradient decrease percentage;
a preoxidation section;
a reduction section;
wherein the electric resistances are distributed on the walls of the said temperature homogenization section or of another section for optionally heating said temperature homogenization section on a time and a length that are given specified above, said time depending on the percentage of the transversal strip temperature gradient decrease percentage.

According to preferred embodiments, the installation is further limited by at least one of the following characteristics or a suitable combination of these characteristics:
the temperature homogenization section or the other section has a length selected according to the line speed and for giving a contact time adjusted or limited to reduce the transversal temperature gradient, expressed by temperature difference divided by distance, at least by 50%;
the temperature homogenization section or the other section has a length selected according to the target line speed and adapted for giving a residence time lower than 12 seconds in order to reduce the transversal temperature gradient at least by 25%;
the temperature homogenization section is lined with refractory material, the electrical resistances being located on the four walls of the section, and preferably on the two sides facing the running strip in use or located so that to minimize the time and length to attain the targeted temperature homogenization;
the tunnel or chamber located ahead of the preoxidation section can be disposed horizontally or vertically, but is preferably disposed vertically to minimize the effects of earth gravity;
the contact roll(s) used as heat capacity reservoir have a diameter higher than 600 mm, but preferably between 800 and 1200 mm, and a thickness of the shell between 10 and 60 mm, but preferably between 20 and 40 mm;
the number of contact roll(s) having a strip wrapping angle higher than 90°, preferably higher than 270°, is comprised between 1 and 6.

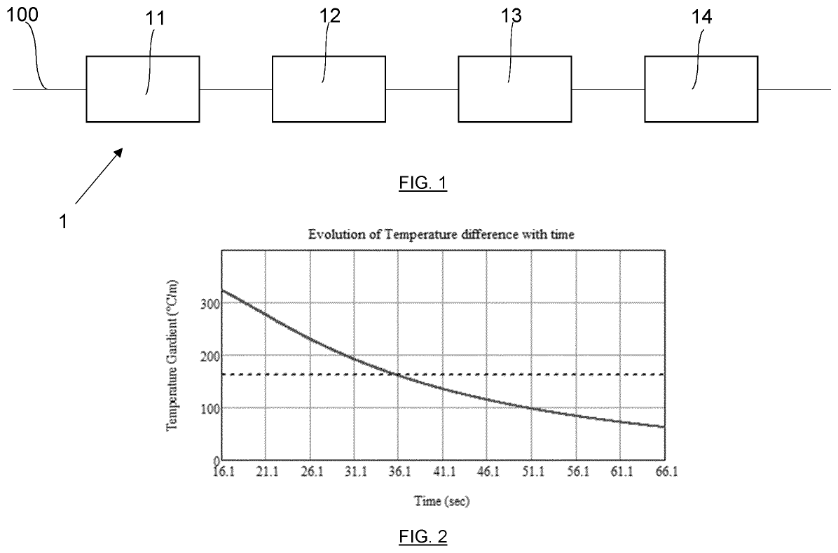

The results presented on FIGS. 2, 4 and 5 have been obtained by thermal simulations based on a simple model of heat transfer relying on energy equilibrium of strip slices taking into account radiation, conduction and convection heat transfer modes. The equations of the model are represented on FIG. 6 (source: M. Dubois, 1996).

Two cases have to be considered when it is intended to compensate for emissivity variation in order to obtain uniform or homogeneous strip temperature.

Firstly, a uniform strip transversal temperature is difficult to obtain when the surface emissivity varies and when the heating rate is high because the thermal conduction has not the time to spread and establish.

The inventors have found that, in order to improve the transversal temperature uniformity, not only a certain time is required but also that the section where this levelling will take place must also have a uniform temperature equal to the target strip temperature. This is to minimize the possible radiative heating difference due to the heating element that needs to be installed to compensate for the heat losses. The inventors have also found in that context that the use of a radiant tubes furnace (RTF) is not a good solution due to the small radiative surface thereof compared to the whole surface of the chamber. The case of gas-flame heated radiant tubes is even worse as it is known that, due to the flame development in the tube, even the temperature of the tube itself is not uniform and depends on the firing rate. A non-uniform tube temperature may be very detrimental to the target as some radiative heating may be in competition with the thermal conductive process that is used to improve the temperature uniformity of the strip.

The inventors finally found that to improves the CO₂ efficiency of the global process, electric heating should be much more recommended than gas heating.

Secondly, the inventors have found that the most efficient way to improve the longitudinal temperature uniformity when it is of limited length, as it is for example the case with coil heads and tails, is to use the heat capacity of rolls the strip wraps around. This is based on the fact that it is well-known that, when the strip has a constant temperature, the contact roll has the same temperature on the contact area and all through the shell thickness.

When a strip section with a different temperature arrives on that roll, a heat exchange proceeds: the heat capacity of the roll is transferred to the strip by contact. Of course such a dynamic effect cannot last too long because the roll temperature tends asymptotically to the strip temperature.

It is also clear that the heat transfer exchange depends on the quality of the strip/roll contact and requires a certain time. The inventors have found the best compromise between the reduction in undesired temperature variation and the number of rolls needed.

To compensate for the strip heat losses of the section, electrical resistances are implemented and controlled in temperature.

### DESCRIPTION OF PREFERRED EMBODIMENTS OF THE INVENTION

### Transversal Temperature Uniformity

According to a preferred embodiment of the invention, a low carbon strip undergoes a heat treatment in a heating installation 1 that consists in heating the strip 100 by radiation either in a direct fired furnace or a full radiant tube furnace 11 to a temperature between 65° and 750° C., and preferably between 65° and 700° C., followed by a dedicated temperature homogenization section 12 located before a preoxidation chamber 13 and a reduction chamber 14 (FIG. 1). The strip temperature is measured at the end of the temperature heating section 11, usually in its center. The line speed is adjusted in such a way that the target temperature, preferentially between 65° and 700° C., is reached.

In the dedicated homogenization section 12, conduction through the strip width can proceed thanks to the time spent in the chamber and the heating by radiation and/or convection is/should be minimized. The design of the chamber comprises a refractory lining intended to minimize heat losses.

According to this disclosure, a controlled electric heating is implemented possibly on the four walls of the section but preferably on the two sides facing the strip. The electric heating is exclusively made of resistances 2 (preferably facing the strip uniformly), electric radiant tubes being excluded. It is therefore intended to provide a targeted so-called “uniform” wall temperature in section 12, that means a temperature with temperature variations of the resistances defined to be lower than about 20° C. The temperature of the resistances is ensured with a measuring device contacting the heating elements on different points but preferentially on each side of the section and preferably on those facing the strip individually. The power of the different resistance panels will be advantageously controlled separately in order to obtain a target temperature that is preferentially between 65° and 700° C.

As the decrease of the temperature gradient requires a certain time, the inventors have found that this time is actually depending on the reduction to the temperature gradient desired from the initial temperature gradient. In the discussion below we define the strip temperature gradient decrease percentage (STGDP) by

$$STGDP = ( \frac{Initial gradient - final gradient}{Initial gradient} ) \times 100$$

For example, if the initial temperature difference is 20° C. on a length of 100 mm transversally to the strip, the gradient is 200° C./m. A gradient reduction of 50% means that the new gradient is 100° C./m so the temperature difference is only 10° C. on 100 mm.

The thermal simulations performed on the basis of the model of FIG. 6 include radiation, convection and conduction with the following data and/or assumptions:
FFD heating of a strip by radiation with a zone temperature of 1250° C. (furnace walls);
the overall emissivity of the strip is 0.315 over most of its surface. In the center, a 50 mm-wide zone has an emissivity 10% higher, i.e. 0.35, according to an emissivity variability assumption;
the target is to obtain a uniform homogenization zone temperature of 650° C., i.e. a value slightly higher than the strip temperature when it exits the FFD (to take advantage of a radiation effect, considering that emissivity is now uniform). This zone is free of forced convection;
a 1 mm-thick steel strip with conductivity λsteel (Tc)=73.29−0.0564 (Tc+273), where Tc is the temperature in ° C. and λsteel the conductivity in W/m (average estimate based on several steels; data from M. Dubois). This conductivity value can even be considered high when compared with alloy steels that are usually even less conductive.

FIG. 2 shows the evolution of the temperature gradient with time for a case where the initial temperature difference across the strip width (100 mm) is 32° C. Time in abscissa is in this case started when the strip enters the furnace but the graph only shows time when the strip enters the homogeneous section of the invention. For reference, the dotted line refers to 50% of temperature gradient decrease (which also corresponds to a STDGP of 50%). It comes then that 20 sec are required for 50% reduction.

The inventors have discovered that the electric resistances 2 distributed on the walls of the section are heating the section on a length that is given in the following equation that depends on the transversal strip temperature gradient decrease percentage or STGDP:

$$Time = A * exp ( B * STGDP )$$

$$and$$

$$Length = Time * line speed$$

$$where :$$

$$STGDP = ( \frac{Initial gradient - final gradient}{Initial gradient} ) \times 100 ;$$

Length is in m, Time in sec, line speed in m/sec;

$$2.8 < A < 3.3 and 0.03 < B < 0.04 .$$

Note that this configuration is here without rolls.

### Longitudinal Temperature Uniformity

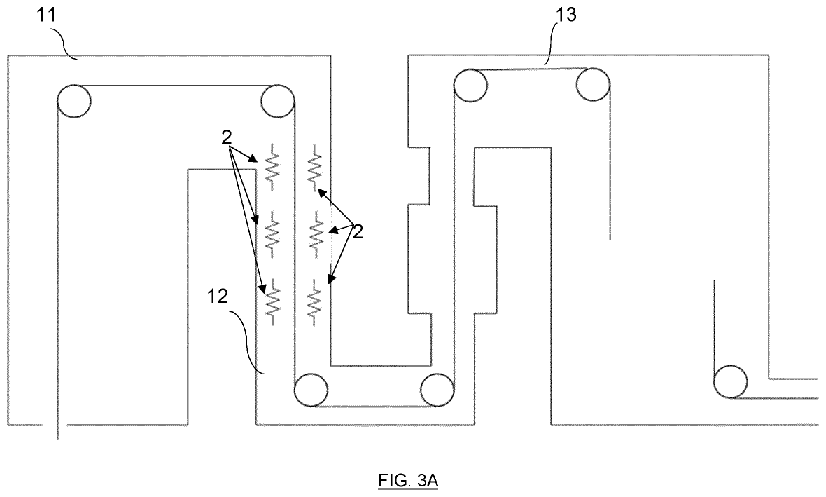

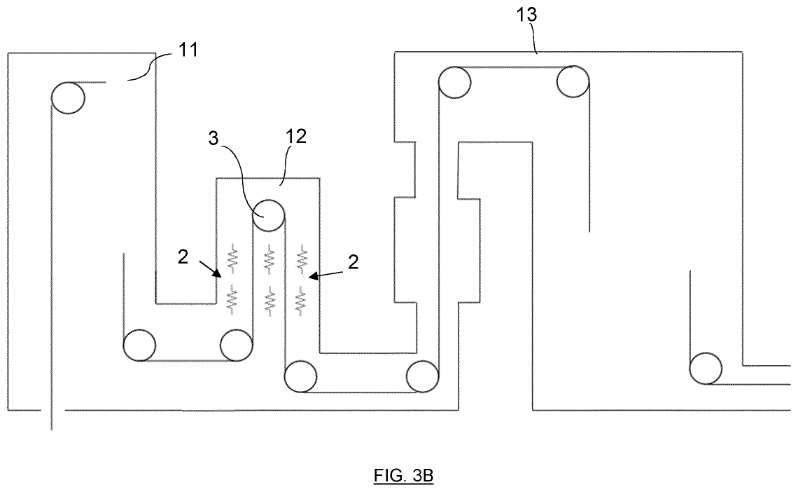

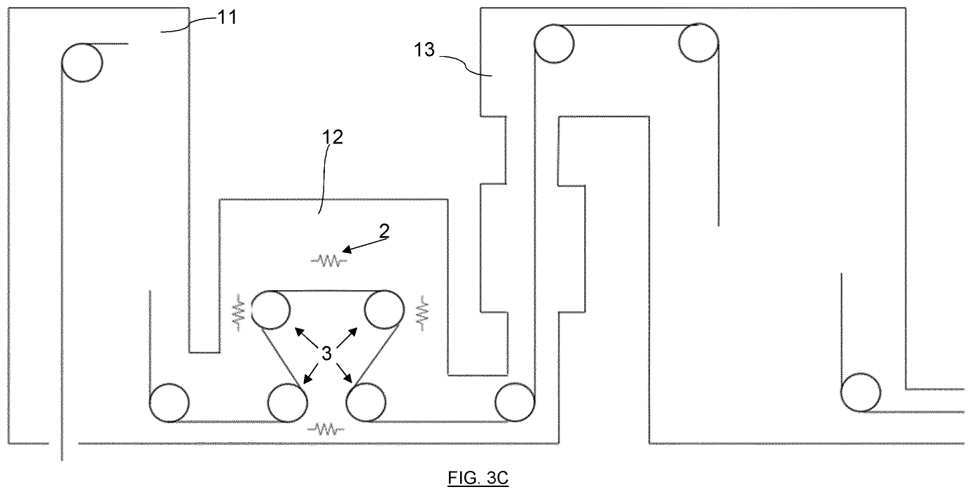

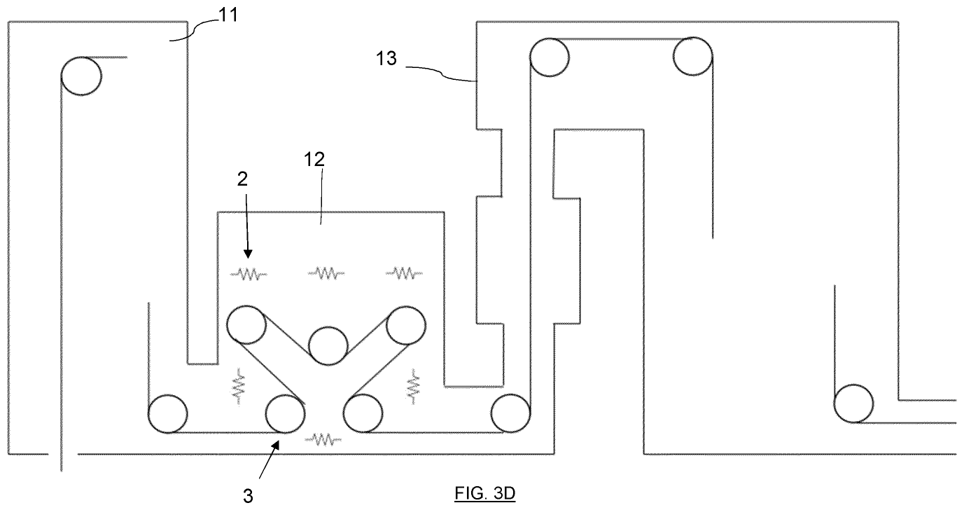

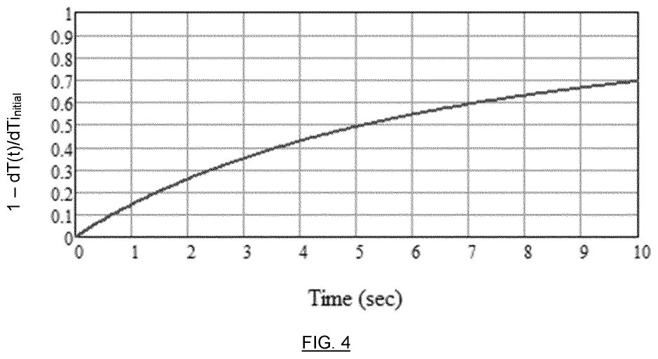

According to another preferred embodiment of the invention, the low carbon strip undergoes a heat treatment that consists in heating the strip 100 by radiation either in a direct fired furnace or a full radiant tube furnace 11 to a temperature between 65° and 750° C., and preferably between 65° and 700° C. followed by passing the strip in a dedicated temperature homogenization section 12 containing at least one contact roll 3, and preferably more contact rolls 3, in order to provide sufficient contact (time) to allow a significant heat exchange between the roll(s) 3 and the strip 100. Different configurations of section 12 are shown on FIGS. 3A to 3D, mainly differing by the number and the location of contact rolls 3 and/or the strip wrapping angle of the rolls 3.

The at least one contact roll 3 is preferably made of a material having of thickness such that to provide sufficient heat capacity (Cp), for example a refractory steel or alternatively a high heat capacity material like carbon. Each roll 3 has a shell thickness between 10 and 60 mm, and preferably between 20 and 40 mm precisely to provide sufficient heat capacity.

The strip tension is controlled in the range of 0.4 to 2 kg/mm², and preferably between 0.8 and 1.2 kg/mm² to ensure a good contact without inducing excessive plastic deformation of the strip that could be detrimental for final flatness. The shape of the rolls 3 is preferably cylindrical that means without special crown but a light crown would be acceptable.

The rolls have a diameter between 600 and 1500 mm, and preferably between 1000 and 1200 mm to ensure reasonable contact length per roll without providing specific layout problems. The rolls are made of refractory stainless steel with the sleeve thickness between 20 and 40 mm, but preferably between 25 and 30 mm

Section 12 is also provided with a number of electric heating devices 2, preferably electric resistances, that are controlled in temperature.

The incoming strip temperature 100 is measured at the end of the temperature heating section 11. The strip temperature at the exit of the series of rolls of the homogenization section 12 is also measured.

Owing to the fact that the decrease, the increase respectively, of the strip temperature requires a certain time, the inventors have found that the required time depends on the reduction in the desired temperature variation. In the discussion below we define the percentage of decrease of the absolute value of the temperature gradient roll/strip (roll/strip temperature gradient decrease percentage or RSTGDP) by:

$$RSTGDP = ( 1 - \frac{dT ( t )}{dT ( t 0 )} \times 100 = ( 1 - \frac{Initial roll temperature - Actual strip temperature}{Initial roll temperature - Initial strip temperature} ) \times 100$$

FIG. 4 shows the time evolution of the roll/strip temperature gradient.

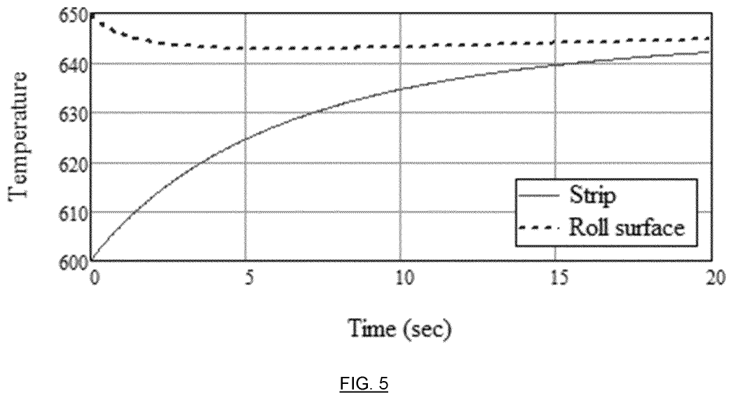

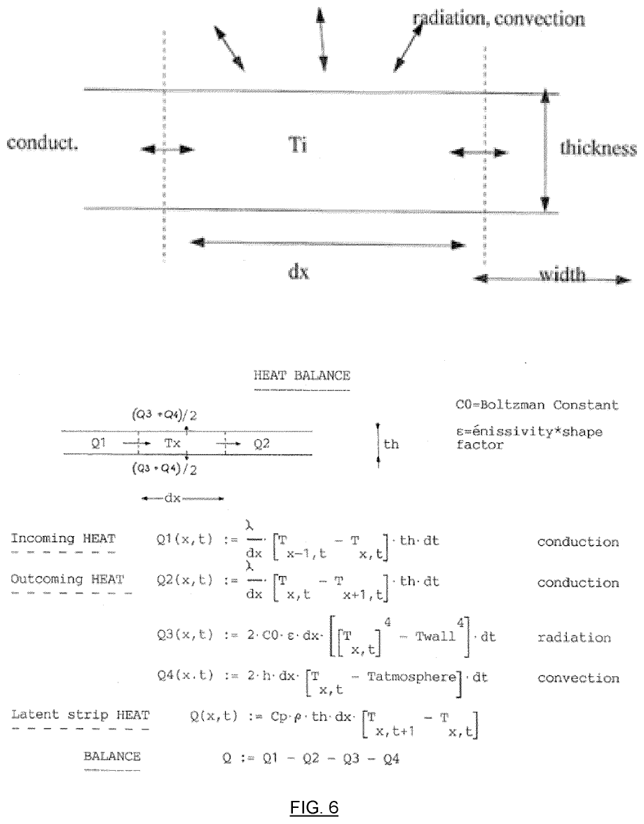

FIG. 5 shows the respective variations of strip temperature and of roll surface temperature with the time spent in the dedicated homogenization section 12, considering a roll initially at 650° C. and a strip entering in the section at 600° C. (1 mm strip, rolls made of refractory steel and with a shell thickness of 25 mm).

The number of rolls required and so the total wrapping contact according to the invention will depend on the size thereof, the inhomogenization reduction target, the line speed and the strip thickness.

The inventors have discovered that the total contact time, the total contact length respectively, of the strip with the at least contact roll (3) are selected greater or equal to

$$Time = ( A * exp ( B * RSTGDP ) ) * strip thickness$$

$$and$$

$$Length = Time * line speed$$

$$where :$$

$$RSTGDP = ( 1 - \frac{Initial roll temperature - Actual strip temperature}{Initial roll temperature - Initial strip temperature} ) \times 100$$

Length is in m, Time in sec, line speed in m/sec; and

$$0.34 < A < 0.92 and 0.035 < B < 0.045 .$$

Roughly the required roll/strip contact time (in seconds) required can be approximated by

$${A}^{′} ( sec / mm ) * strip thickness ( mm )$$

with the value of A′ as follows:
for 25% temperature gradient percentage decrease (RSTGPD): 1<A′<3;
for 50% temperature gradient percentage decrease (RSTGPD): 3<A′<8;
for 75% temperature gradient percentage decrease (RSTGPD): 8<A′<12.

Document of Ph. Paulus et al, Study of the heat buckling and shape problems in continuous heat treating lines and discussion of proposed solutions, Metallurgical Soc. Of AIME, Warrendale, PA, 1985, pp. 419-439, teaches that the temperature difference between the roll and the strip should not be too big in order to avoid strip deformation (buckles). Typically the initial temperature difference between the roll and the strip should not be greater than 100° C., and preferably greater than 50° C.

Practically it means that, if a strip of 1 mm thickness is running at 120 mpm (2 mps) and arrives at 600° C. on rolls at 650° C., the total contact time with rolls needed to ensure a strip finally at 625° C. (50% decrease of the gradient) should be at least comprised between 3 and 8 sec. Considering the line speed and the wrapping angles, the roll diameter, the number of rolls needed is then easy to compute by the skilled person.

In order to ensure good contact between the rolls and the strip, the strip tension is advantageously comprised between 0.3 and 1.5 kg/mm², and preferably between 0.5 and 1 kg/mm².

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

1 Heating installation
2 Electric resistance(s)
3 Contact roll(s)
11 DFF or RTF section
12 Homogenization section
13 Preoxidation section
14 Reduction section
100 Steel strip

1. A method for improving temperature longitudinal homogeneity of a steel strip comprising a low carbon alloyed steel strip dedicated to liquid metal coating, the method comprising:
continuously running the steel strip at a line speed in a temperature homogenization section provided with electric resistances, the temperature homogenization section being located before a post-treatment section and after a furnace section, the furnace section being configured to provide a radiative or electric heating of the steel strip to a predetermined average temperature, the temperature homogenization section including at least one contact roll comprising refractory stainless steel, the at least one contact roll having a strip wrapping angle higher than 90°,
wherein a total contact time and a total contact length, respectively, of the strip with the at least one contact roll are selected to be greater or equal to
$$ContactTime 1 = ( A * exp ( B * RSTGDP ) ) * strip thickness$$
$$and$$
$$ContactLength 1 = ContactTime 1 * line speed$$
$$where - :$$
$$RSTGDP = ( 1 - \frac{Initial roll temperature - Actual strip temperature}{Initial roll temperature - Initial strip temperature} ) \times 100$$
ContactLength1 is in m, ContactTime1 in sec, line speed in m/sec, and
0.34<A<0.92 and 0.035<B<0.045,
wherein ContactTime1 is limited to a value necessary to attain a predetermined upper value of RSTGDP, the initial roll temperature, and
wherein the initial and actual strip temperatures in the temperature homogenization section are measured by temperature measurement devices.

2. The method of claim 1, wherein the total contact time ContactTime1 is adjusted or limited to obtain a reduction by 25% of a longitudinal temperature variation of the strip.

3. The method of claim 1, wherein a temperature of the temperature homogenization section is controlled by setting a temperature of the electric resistances at an average value to obtain a temperature value required for the strip entering the preoxidation section, the electric resistances having a function of compensating thermal loss.

4. The method of claim 1, wherein the temperature homogenization section is maintained under an atmosphere with less than 0.5% O₂.

5. The method of claim 1, wherein the temperature homogenization section is maintained under an atmosphere having a dew point between −60 and 0° C.

6. The method of claim 1, wherein, in the temperature homogenization section or in another section, electric resistances distributed on walls of the section heat the section on a length that is given in the following equation that depends on a transversal strip temperature gradient decrease percentage or STGDP:
$$ContactTime 2 = A * exp ( B * STGDP )$$
$$and$$
$$ContactLength 2 = ContactTime 2 * line speed$$
$$where - :$$
$$STGDP = ( \frac{Initial gradient - Final gradient}{Initial gradient} ) \times 100 - ;$$
ContactLength2 is in m, ContactTime2 in sec, line speed in m/sec, and
2.8<A<3.3 and 0.03<B<0.04.

7. The method of claim 1, wherein the post-treatment section comprises a preoxidation section or a soaking section.

8. The method of claim 1, wherein the furnace section comprises a direct flame furnace, a radiant tube furnace, or an electric induction furnace.

9. The method of claim 8, wherein the furnace section is maintained under an atmosphere containing less than 1% O₂ and at least one of H₂, CO, H₂O, CO₂, N₂, or a mixture thereof, in respective proportions depending on processing parameter settings.

10. The method of claim 1, wherein a strip tension is between 0.3 and 1.5 kg/mm².

11. The method of claim 1, wherein a temperature difference between the strip entering the temperature homogenization section and the at least one contact roll is lower than 100° C.

12-18. (canceled)

19. The method of claim 1, wherein the strip wrapping angle is higher than 270°.

20. The method of claim 2, wherein the total contact time ContactTime1 is adjusted or limited to obtain a reduction by 50% of the longitudinal temperature variation of the strip.

21. The method of claim 5, wherein the temperature homogenization section is maintained under an atmosphere having a dew point between −30 and −10° C.

22. The method of claim 11, wherein the temperature difference between the strip entering the temperature homogenization section and the at least one contact roll is lower than 50° C.
